(19) United States
(12) Patent Application Publication
(10) Pub. No.: US 2006/0005798 A1
(43) Pub. Date: Jan. 12, 2006

(54) Variable intake system of a vehicle

(76) Inventor: Dong Ho Chu, Ansan-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/024,870

(22) Filed: Dec. 28, 2004

(30) Foreign Application Priority Data
Jul. 6, 2004 (KR) 10-2004-0052420

(51) Int. Cl. F02M 35/10

(52) U.S. Cl. 123/184.55

(57) ABSTRACT

A variable intake system of a vehicle includes an intake manifold having a runner, an opening/closing part for varying the runner length of the intake manifold, an actuator for driving the opening/closing part, and a vacuum part forming a vacuum chamber for driving the actuator. The vacuum part is disposed on an upper portion of the intake manifold such that noise from the engine may be decreased.

### CROSS-REFERENCE TO RELATED APPLICATIONS

This application claims priority of Korean Application No. 10-2004-0052420, filed Jul. 6, 2004, the disclosure of which is incorporated herein by reference.

### FIELD OF THE INVENTION

Generally, the present invention relates to an engine for a vehicle. More particularly, the present invention relates to a variable intake system of a vehicle.

### BACKGROUND OF THE INVENTION

There are various kinds of engines for a vehicle. Among them, an engine with a variable intake system varies the effective length of runners of the intake manifold according to vehicle driving conditions. As is generally known, such a variable intake system generally includes a throttle body, a plenum connected with the throttle body, an intake manifold having a plurality of runners receiving an air from the plenum, a passing part disposed on a predetermined portion of the intake manifold, an opening/closing part for opening and closing the passing part according to the vehicle driving condition (e.g., vehicle travel speed, etc.), and a motor driving the opening/closing part.

In order to reduce the weight of an engine, attempts have been made to change the materials used in variable intake systems to plastic materials. However, if the material of the variable intake system is changed to a plastic material, it has been experimentally found that noise increases. Such a noise increase phenomenon may occus because the flow rate suddenly increases due to a decrease of a friction loss when the air passes through the throttle body. Subsequently, such noise is also generated while the air passes through the runners of the intake manifold. In addition, such an intake noise may also be generated by a rotation of a crankshaft.

The information disclosed in this Background of the Invention section is only for enhancement of understanding of the background of the invention and should not be taken as an acknowledgement or any form of suggestion that this information forms the prior art that is already known in this country to a person of ordinary skill in the art.

### SUMMARY OF THE INVENTION

Embodiments of the present invention provide a variable intake system of a vehicle having non-limiting advantages of reducing weight and cost while effectively decreasing noise of the engine.

An exemplary variable intake system of a vehicle according to an embodiment of the present invention includes an intake manifold having a runner, an opening/closing part for varying the runner length, an actuator for driving the opening/closing part, and a vacuum part forming a vacuum chamber for driving the actuator. The vacuum part may be disposed on an upper portion of the intake manifold such that noise is decreased.

In a further embodiment according to the present invention, the vacuum part includes a body disposed on the upper portion of the intake manifold and having an opening portion at any one surface thereof, and a cover disposed on the opening portion of the body.

In another further embodiment according to the present invention, the body is monolithically formed with an upper surface of the intake manifold.

In another further embodiment according to the present invention, a sound-absorbing material layer is disposed on at least one surface of the cover.

In another further embodiment according to the present invention, the opening portion is formed at the upper portion of the body; and the sound-absorbing material layer is disposed on a lower surface of the cover.

### BRIEF DESCRIPTION OF THE DRAWINGS

The accompanying drawings illustrate exemplary embodiments of the present invention, and, together with the description, serve to explain the principles of the present invention, wherein:

FIG. 1 is a cutaway view in perspective of a variable intake system of a vehicle according to an embodiment of the present invention;

FIG. 2 is a block diagram of a driving unit for driving an opening/closing part in a variable intake system of a vehicle according to an embodiment of the present invention;

FIG. 3 is an exploded perspective view showing a variable intake system of a vehicle according to an embodiment of the present invention;

FIG. 4 is an enlarged view of part “A” in FIG. 3; and

FIG. 5 is another perspective view showing a variable intake system of a vehicle according to an embodiment of the present invention.

### DETAILED DESCRIPTION OF THE EMBODIMENTS

An embodiment of the present invention will hereinafter be described in detail with reference to the accompanying drawings.

In the following description, principal components of a variable intake system of a vehicle according to an embodiment of the present invention will firstly be described, and after this, means for decreasing noise of an engine according to embodiments of the invention will be described.

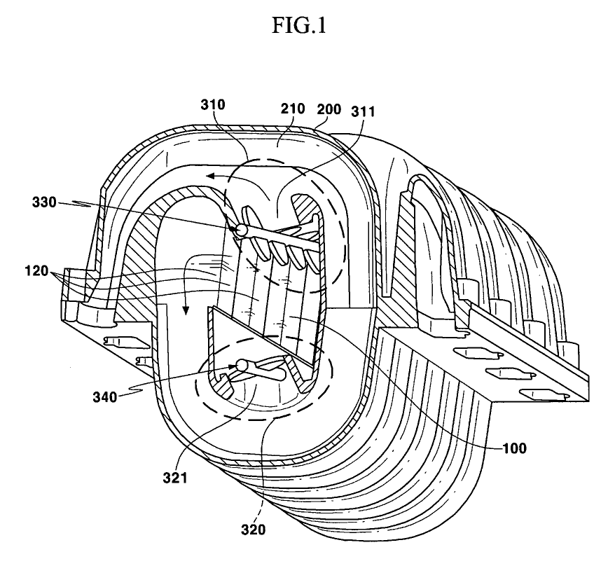

As shown in FIG. 1, a variable intake system of a vehicle according to an embodiment of the present invention includes a plenum 100 for receiving an external air, and an intake manifold 200 having at least one runner 210 for guiding the air from the plenum 100 into a cylinder. Also included is a connecting passage 120 formed at an end of the intake manifold 200 so as to be connected with the plenum 100.

The variable intake system of a vehicle according to an embodiment of the present invention further includes a first connecting part 310, and a second part 320. The first connecting part 310 is provided to an upper portion of the plenum 100 and connects the plenum 100 and the intake manifold 200. The second connecting part 320 is provided to a lower portion of the plenum 100 and connects the plenum 100 and the intake manifold 200.

Furthermore, the first connecting part 310 is provided with a first guide passage 311 and a first opening/closing part 330, and the second connecting part 320 is provided with a second guide passage 321 and a second opening/closing part 340. The first and the second opening/closing parts 330 and 340 are driven by a driving unit utilizing a vacuum as follows.

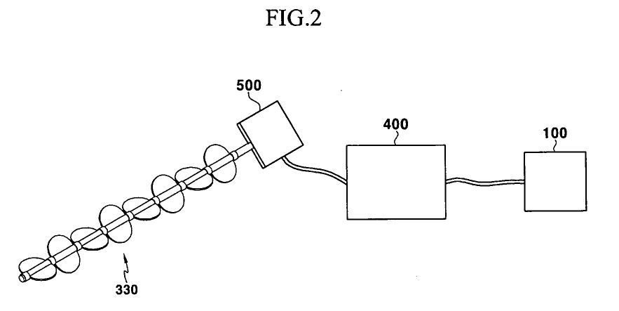

As shown in FIG. 2, the driving unit includes a vacuum part 400 and an actuator 500. The vacuum part 400 is connected to the plenum (see “100” in FIG. 1), and forms a vacuum chamber that is changed between a vacuum state and a standard state according to a negative pressure of the plenum 100. The actuator 500 is connected with the vacuum part 400, and has a diaphragm disposed inside thereof. Accordingly the diaphragm is expanded or contracted according to the pressure state of the vacuum chamber, and the opening/closing part is driven according to the expansion/contraction of the diaphragm. Such a driving unit has an advantage that production cost may be lower than in a conventional scheme using a motor operated by electric power.

Operation of the variable intake system of a vehicle according to the embodiment of the present invention will hereinafter be described in detail with reference to FIGS. 1 and 2.

Firstly, when a vehicle is running at a high speed, the second opening/closing part 340 is rotated by the actuator 500, and it closes the second guide passage 321 of the second connecting part 320.

At that same time, the first opening/closing part 330 is rotated by the actuator 500, and it widely opens the first guide passage 311 of the first connecting part 310.

Accordingly, the air in the plenum 100 flows into the intake manifold 200 through the first guide passage 311 of the connecting part 310. Therefore, the length of the runner 210 becomes effectively shortened. In the intake manifold 200, the air that has passed through the guide passage 311 is mixed with the air that has passed through the connecting passage 120.

On the other hand, when the vehicle is running at low speed, the second passage 321 of the second connecting part 320 is opened and the first passage 311 of the first connecting part 310 is closed. Therefore, the length of the runner 210 becomes effectively lengthened.

A means for decreasing a noise in the variable intake system of a vehicle according to the embodiment of the present invention will hereinafter be described in detail.

Firstly, noise emitted from an engine can be decreased, since a variable intake system of a vehicle according to an embodiment of the present invention employs the driving unit utilizing a vacuum instead of the conventional motor utilizing an electric power.

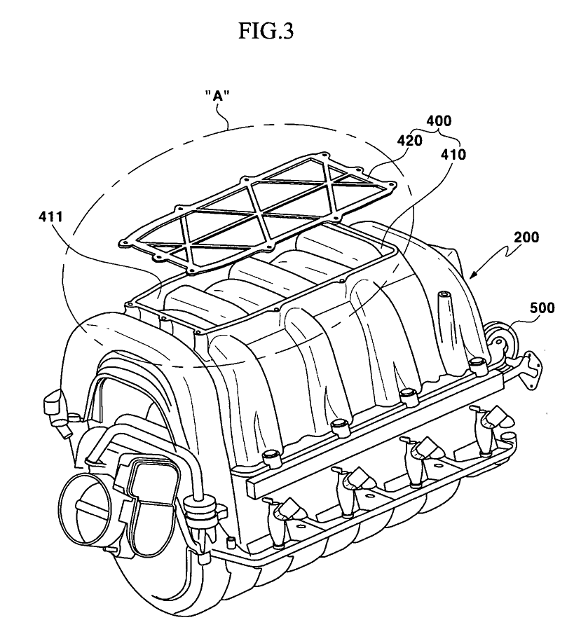

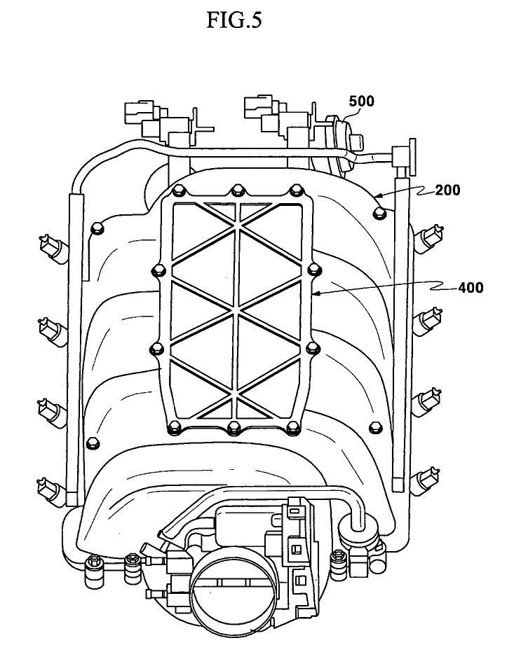

For example, as shown in FIGS. 3 to 5, a means for decreasing such noise can be realized by disposing the vacuum part 400 on an upper portion of the intake manifold 200 intensively emitting a noise in the engine. According to a general arrangement of an engine in an engine compartment, an upper surface of the intake manifold 200 emits more noise than any other surface thereof. The upper surface of the intake manifold 200 is where an engine cover (not shown) for decreasing noise is generally disposed. Therefore, it is preferable that the vacuum part 400 is disposed on the upper portion of the intake manifold 200 so as to absorb the noise of the engine.

Noise emitted from side surfaces of the engine may be decreased by neighboring members located to the side surfaces thereof. However, noise emitted from the upper portion of the intake manifold 200 is not decreased since the upper portion usually does not have any neighboring members. Accordingly, it is preferable that the vacuum part 400 be disposed on the upper portion of the intake manifold 200.

In addition, since the vacuum part 400 is disposed on the upper surface of the intake manifold 200, a conventional engine cover is not required. Accordingly, a cost can be decreased. Adopting such a driving unit does not cause extra cost since the driving unit including the vacuum part 400 and the actuator 500 is used to replace the conventional motor.

It is preferable that the vacuum part 400 includes a body disposed on the upper surface of the intake manifold 200, having an opening portion 411 at any one surface thereof, and a cover 420 disposed on the opening portion 411 of the body 410. It also may be preferable that the body 410 be monolithically formed with the upper surface of the intake manifold 200. Particularly, if the intake manifold 200 is formed of a resin, the body 410 and the intake manifold 200 may be formed as one body by an injection molding process.

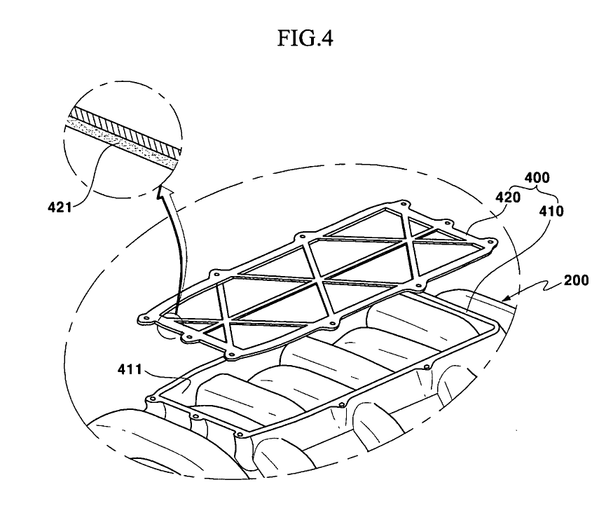

Accordingly, a gap may be eliminated from between the upper surface of the intake manifold 200 and a lower surface of the vacuum part 400, and therefore, noise emitted from the upper surface of the intake manifold 200 does not leak and is reduced by the vacuum chamber. In addition, manufacturing cost can be further reduced since the body 410 and the intake manifold 200 are formed by injection molding at the same time. A sound-absorbing material layer (see “421” in FIG. 4) may be disposed on at least one surface of the cover 420.

Accordingly, noise firstly decreased through the vacuum chamber of the vacuum part 400 can be further decreased by the sound-absorbing material layer 421. Particularly, it is more preferable that the opening portion 411 is formed at the upper portion of the body 410, and the sound-absorbing material layer 421 is disposed on a lower surface of the cover 420. By such a location of the sound-absorbing layer 421, the noise can be additionally decreased by the sound-absorbing material layer 421 before transmitting to the cover 420.

A noise decreasing process in the variable intake system of a vehicle according to the embodiment of the present invention will hereinafter be described in detail.

Firstly, most of the noise generated in the engine is emitted from the upper surface of the intake manifold 200.

The noise is firstly decreased through a vacuum layer of the vacuum chamber having a different air density. More specifically, a propagation direction of the noise through the vacuum layer is changed due to the density difference, and accordingly a transmittance of the noise is decreased.

After this, the noise passing through the vacuum layer is additionally decreased by the sound-absorbing material layer 421.

As has been explained above, the variable intake system of a vehicle according to an embodiment of the present invention has several advantages. For example, since a driving unit using a vacuum is employed, cost can be reduced in comparison with a scheme that utilizes a conventional motor operated electric power. In addition, since the driving unit using the vacuum is also a means for decreasing noise, noise emitted from the engine can be considerably decreased without causing an increase of manufacturing cost.

While this invention has been described in connection with what is presently considered to be the most practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A variable intake system of a vehicle, comprising:
an intake manifold having a runner with a length;
an opening/closing part for varying runner length of the intake manifold;
an actuator for driving the opening/closing part; and
a vacuum part forming a vacuum chamber for driving the actuator,
wherein the vacuum part is disposed on an upper portion of the intake manifold such that a noise of an engine may be decreased.

2. The variable intake system of claim 1, wherein the vacuum part comprises:
a body disposed on the upper portion of the intake manifold and having an opening portion at any one surface thereof; and
a cover disposed on the opening portion of the body.

3. The variable intake system of claim 2, wherein the body is monolithically formed with an upper surface of the intake manifold.

4. The variable intake system of claim 3, wherein a sound-absorbing material layer is disposed on at least one surface of the cover.

5. The variable intake system of claim 4, wherein the opening portion is formed at the upper portion of the body; and
wherein the sound-absorbing material layer is disposed on a lower surface of the cover.
